(19) United States
(12) Patent Application Publication
(10) Pub. No.: US 2011/0263292 A1
(43) Pub. Date: Oct. 27, 2011

(54) CONTACTLESS PAYMENT CARD OPTIMIZED FOR ATTACHMENT TO MOBILE SMART PHONE

(76) Inventor: Simon Phillips, York (GB)

(21) Appl. No.: 12/765,218

(22) Filed: Apr. 22, 2010

(51) Int. Cl. G06K 19/07; H04W 88/02; G06K 19/06

(52) U.S. Cl. 455/556.1; 235/492; 235/493

(57) ABSTRACT

A payment card includes an ID-1-sized plastic body, which has a left edge, a right edge, a top edge and a bottom edge. The payment card also includes an integrated circuit (IC) embedded in the plastic body. The IC stores a payment card account number. Also included in the payment card is an antenna that is coupled to the IC for the purpose of selectively transmitting the payment card account number from the payment card. The antenna is embedded or printed on the plastic body and configured such that no portion of the antenna is closer than about one inch from the right edge of the plastic body. In addition, the payment card includes a magnetic stripe formed on the rear surface of the plastic body and storing the payment card account number.

### BACKGROUND

In U.S. patent application Ser. No. 12/356,367, filed Jan. 20, 2009 (and incorporated herein by reference), the present inventor disclosed a technique for securing a small contactless payment card to a mobile telephone. According to this technique, a protective case for the mobile telephone includes a slot or pocket into which the contactless payment card is inserted, at a time when the mobile telephone also has been installed in the case. As is well known, contactless payment cards allow account holders to access debit or credit card accounts to pay for transactions by wireless communication between the contactless payment cards and proximity readers included in point of sale (POS) terminals. When a contactless payment card is secured to the mobile telephone by a protective case as described in the '367 patent application, payment for a transaction may be effected by tapping the mobile telephone on the POS proximity reader.

The technique described in the '367 patent application provides a number of advantages, particularly in view of the small form factors for mobile telephones that have generally prevailed in recent years. However, with the advent and widespread adoption of the “iPhone” mobile smart phone (sold by Apple, Inc.) it may now be desirable to adapt the technique of the '367 patent application to securing an ID-1 contactless payment card to the iPhone or similar devices. This modification of the teachings of the '367 patent application may be desirable because an ID-1 card, unlike the small contactless payment card shown in the '367 patent application, may include a magnetic stripe, and thus may be usable with POS magnetic stripe readers as well as proximity readers. This modification of the teachings of the '367 patent application is feasible because the substantially 4.5 inch by 2.4 inch form factor—and planar rear surface—of the iPhone would readily accommodate the ID-1 form factor (substantially 3.37 inches by 2.125 inches).

However, the present inventor has recognized a potential problem with this proposed modification of the teachings of the '367 patent application, a problem not recognized in the prior art. According to this potential problem, if a conventionally configured ID-1 contactless payment card were secured via a mobile phone case to an iPhone, the result may be that a portion of the antenna of the payment card may overlie the antenna of the iPhone, thereby potentially interfering with proper functioning of the iPhone and/or adversely affecting the SAR (Specific Absorption Rate) of the iPhone, and thus possibly giving rise to safety concerns as well as performance issues for the phone.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a schematic view of a cross-section, taken vertically, of a mobile telephone having a contactless identification card removably secured thereto in accordance with aspects of the present invention.

FIG. 2 is a simplified plan view of an example of the contactless identification card seen in FIG. 1.

FIG. 3 is a view similar to FIG. 2, but showing internal components of the contactless identification card.

FIG. 4 is a rear-surface plan view of the contactless identification card.

FIG. 5 schematically illustrates a positional relationship between embossed characters on the contactless identification card and a portion of the card antenna.

FIG. 6 schematically illustrates a positional relationship between respective antennas of the mobile telephone and the contactless identification card shown in FIG. 1.

FIG. 7 is a flow chart that illustrates a process that may be performed with respect to the mobile telephone/contactless identification card combination of FIG. 1.

FIG. 8 schematically illustrates some communication aspects of a purchase transaction performed using the mobile telephone/identification card combination of FIG. 1.

FIG. 9 schematically illustrates some physical aspects of the purchase transaction of FIG. 8.

### DETAILED DESCRIPTION

In general, and for the purpose of introducing concepts of embodiments of the present invention, the antenna component of an ID-1-sized contactless payment card is configured so as to be about one inch distant from the right-hand edge of the card. With this antenna configuration, the card may be inserted into a slot of a protective case for an iPhone or similar device, without resulting in interference by the card antenna with functional characteristics of the iPhone.

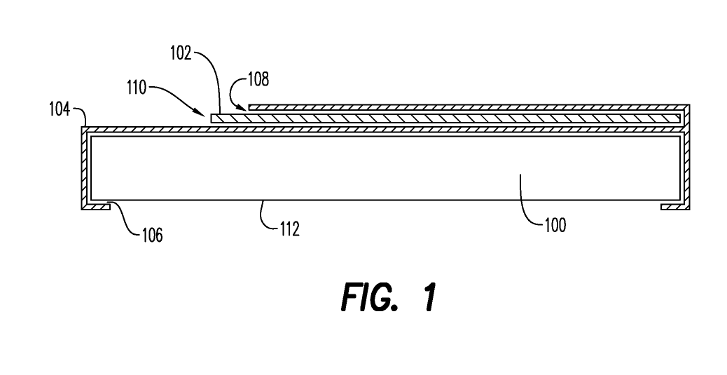

FIG. 1 is a schematic view of a cross-section, taken vertically, of a mobile telephone 100 having a contactless identification card 102 removably secured thereto in accordance with aspects of the present invention.

The mobile telephone 100 may be entirely conventional, and may, for example, be the widely-used iPhone mobile smart phone, as mentioned above. As is well known, the iPhone includes a relatively large touch screen, an operating system that supports numerous applications (“apps”) and a telephone antenna (hidden within the body of the phone) by which voice and data signals are transmitted to and from the phone.

The contactless identification card 102 may, for example, be a credit card or debit card, and/or may identify the individual who holds the card for purposes other than or in addition to payment. For example, the card may be a transit system access card, a retail customer loyalty card, a gym membership card, a building or office suite access card, etc. However, for the most part hereinafter the card 102 will be referred to as “contactless payment card 102”. Details of the contactless payment card 102 will be provided below.

In accordance with an aspect of the present invention, the mechanism that secures the contactless payment card 102 to the mobile telephone 100 may be an article of manufacture such as a protective carrying case 104 for the mobile telephone 100. In some ways the protective case 104 may be conventional, and may for example generally resemble an item such as the “Elan Form Chrome” carrying case, available from Griffin Technology, Nashville, Tenn. The protective case 104 may, for example, generally form a pouch 106 that is shaped and sized to receive the mobile telephone 100. It will be appreciated that the pouch 106 may serve as a mechanism that secures the protective case 104 to the mobile telephone 100 and vice versa.

In accordance with aspects of the present invention, the protective case 104 may include a slot or pocket 108 which is schematically shown in the drawing (and which is an additional feature not present, e.g., in the above-mentioned Elan Form Chrome protective case). The slot is defined by full and/or partial sheets of material from which the protective case 104 is formed, those sheets of material thus constituting a mechanism for defining the slot 108. The slot 108 is shaped and sized to receive and securely hold the contactless payment card 102. It will be understood that the manner of the contactless payment card 102 being “securely held” in the slot 108 may be a consequence of frictional forces resulting from a fairly snug fit of the contactless payment card 102 inside the slot 108. By the same token, if the user (not shown) were to grip an edge of the contactless payment card 102 at the opening 110 of the slot 108, the user may be able to readily withdraw the contactless payment card 102 from the slot 108.

(In the illustration presented in FIG. 1, the front/touch screen surface 112 of the iPhone is shown facing downwardly, so that the payment card 102 is secured adjacent the rear surface of the iPhone 100.)

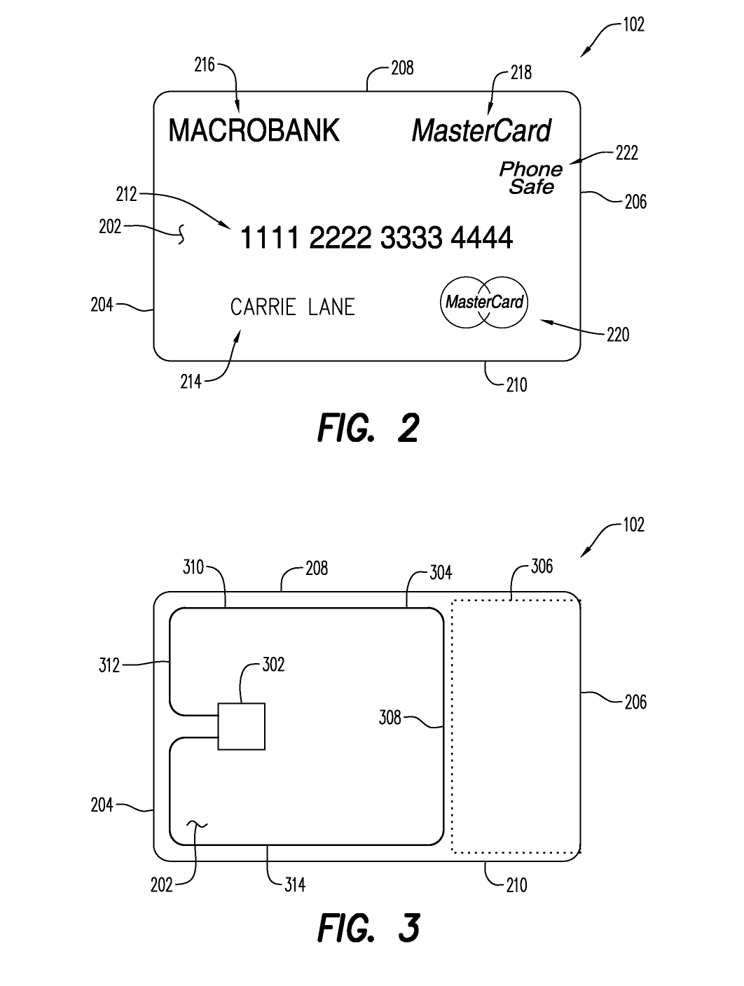

According to an aspect of the invention, the contactless payment card 102 may be in the familiar ID-1 form factor. FIG. 2 is a simplified front surface plan view of the contactless payment card 102.

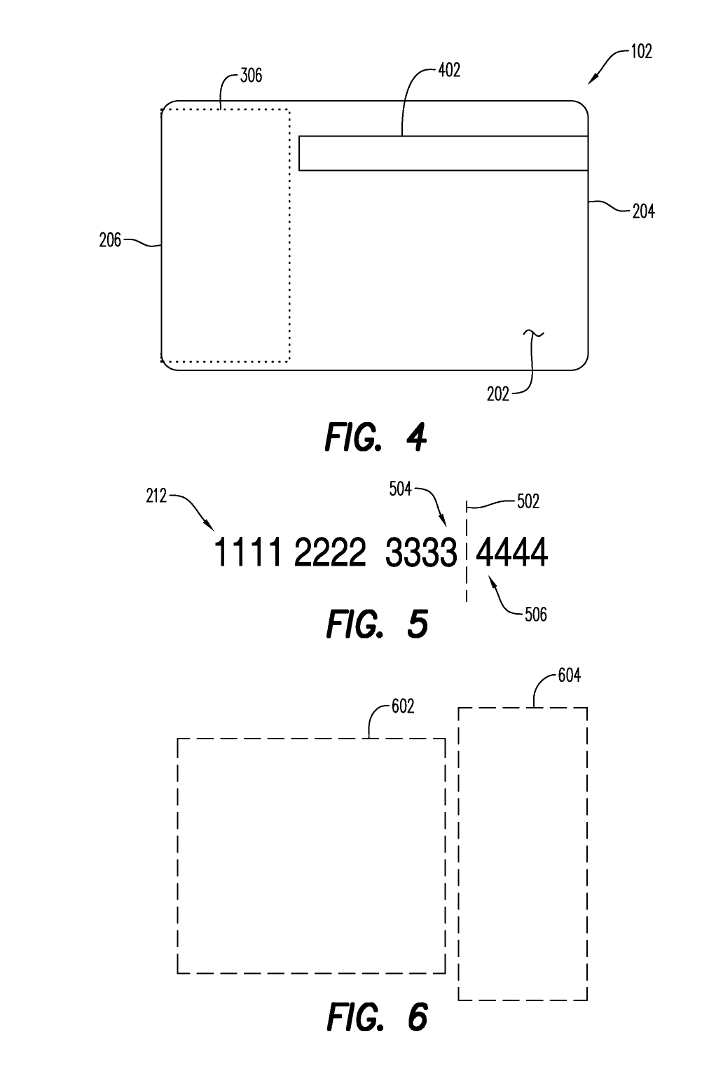

The contactless payment card 102 includes a card-shaped body 202 (e.g., laminated from layers of plastic) in the ID-1 form factor. The plastic card body 202 has a left edge 204, a right edge 206, a top edge 208 and a bottom edge 210. (To define the term “right edge” in more detail, that term refers to the right-hand side edge of the payment card as the front-surface of the payment card is viewed with printing on the front-surface oriented for normal reading (i.e., with the printing “right-side up”).) In its appearance, the front surface of the contactless payment card 102 may resemble conventional payment cards, and may display a payment card account number presented in embossed numerals 212. The contactless payment card 102 may also display, on its front surface, the cardholder's name 214, the name 216 of the issuing bank, the brand 218 of the authorizing payment card system (in this case “MasterCard”, indicating that the contactless payment card 102 is issued under the authority of MasterCard International Incorporated, the assignee hereof), and the payment card system logo 220. In addition, in accordance with an aspect of the present invention, the front surface of the contactless payment card 102 may display a legend or logo 222 that is indicative that the contactless payment card 102 is configured such as to avoid interference with operation/functional characteristics of the mobile telephone 100. Details of such configuration of the contactless payment card 102 will be described below in conjunction with FIGS. 3 and 4.

The front surface of the contactless payment card 102 may present additional information which is not shown in the drawing, such as the card expiration date.

FIG. 3 is a view similar to FIG. 2, but showing internal components of the contactless payment card 102. The internal components include an RFID (radio frequency identification) chip 302 (IC or integrated circuit) embedded in the plastic card body 202, and an antenna 304, also embedded in the plastic card body 202. In accordance with an aspect of the invention, the width of the configuration of the antenna 304 is reduced, relative to the conventional payment card antenna configuration, and such that the antenna 304 does not intrude on a keep-out zone 306 that extends left-ward for about an inch from the right edge 206 of the plastic card body 202. Accordingly, the right course 308 of the antenna 304 is adjacent to, but outside of, the keep-out zone 306 and is no closer than about one inch from the right edge 206 of the plastic card body 202. The top course 310 of the antenna is adjacent the top edge 208 of the plastic card body 202; the left course 312 of the antenna is adjacent the left edge 204 of the plastic card body 202; and the bottom course 314 of the antenna is adjacent the bottom edge 210 of the plastic card body 202. (In some embodiments, as an alternative, the bottom course of the antenna may be spaced from the bottom edge 210 of the plastic card body 202, in accordance with a known practice, in order to be clear of the locus of so-called “fourth line embossing” on the card body.)

The antenna 304 is coupled to the RFID chip 302 to allow the RFID chip 302 to receive interrogation signals from proximity reader devices included in POS terminals. The antenna 304 also allows the RFID chip 302 to transmit payment card account information and other information to the POS terminals. It will be appreciated that the RFID chip may store, in the form of digital data, the payment card account number displayed on the front surface of the contactless payment card 102. The contactless payment card 102 may operate in accordance with conventional practices. For purposes of illustration, the RFID chip and antenna are shown in FIG. 3, but in practical examples of the contactless payment card 102 the card body may be formed largely of opaque plastic and the RFID chip and antenna may be embedded in the opaque plastic so as not to be visible.

FIG. 4 is a rear-surface plan view of the contactless payment card 102.

In accordance with conventional practice, the rear surface of the contactless payment card 102 carries a magnetic stripe 402 which extends from one side edge of the card body towards the opposite side edge, except that the magnetic stripe 402—in accordance with an aspect of the present invention—stops short of the above-mentioned keep-out zone 306, instead of extending all the way across the width of the plastic card body 202, as do conventionally configured magnetic stripes for payment cards. The purpose of this reduced configuration of the magnetic stripe 402 is again (like the configuration of the card antenna) to reduce or prevent interference with the operation/functional characteristics of the mobile telephone 100 when the contactless payment card 102 is secured to the mobile telephone 100 in the manner illustrated in FIG. 1.

Continuing to refer to FIG. 4, it will be noted that the magnetic stripe 402 does not approach closer than about one inch relative to the edge 206 of the plastic card body 202 (which edge 206 was referred to in connection with FIGS. 2 and 3 as the “right edge” of the plastic card body 202, although presented at the left side of FIG. 4). (It will be noted that the magnetic stripe 402 extends from the left edge 204—shown at the right side of FIG. 4—of the card body about two-thirds of the way toward the right edge 206.)

The magnetic stripe 402 may store the same payment card account number stored in the RFID chip 302 and displayed on the front surface of the contactless payment card 102. The magnetic stripe 402 may be configured to allow conventional magnetic stripe reader components of POS terminals to read the payment card account number and other information from the magnetic stripe 402.

(The rear surface of the payment card may also include conventional features that are not indicated in FIG. 4. Such features may include, for example, an adhesive paper strip for receiving the cardholder's handwritten signature, a printed CVC security code, a printed customer service toll-free telephone number, a hologram for security purposes, various logos or legal notices, etc.)

FIG. 5 schematically illustrates a positional relationship between embossed characters on the contactless payment card 102 and a portion of the card antenna. The dashed line 502 in FIG. 5 represents a portion of the right course 308 of the card antenna 304 passing between the twelfth numeral 504 and the thirteenth numeral 506 of the 16-digit embossed payment card account number 212. With this arrangement, the embossing of the payment card account numerals on the plastic card body will not disrupt or adversely affect the card antenna. (In another arrangement, the antenna may be of a type that is printed on the plastic card body, such that the antenna would likely not be disrupted by having one or more characters embossed thereon, in which case the positional relationship shown in FIG. 5 may be dispensed with.)

FIG. 6 schematically illustrates a positional relationship between respective antennas of the mobile telephone 100 and the contactless payment card 102 when secured together as shown in FIG. 1. In particular, dashed line rectangle 602 indicates the locus of the card antenna 304, whereas dashed line rectangle 604 indicates the locus of the antenna of the mobile telephone 100. It will be noted that the card antenna and the phone antenna do not overlap each other, and consequently, the card antenna is offset from the phone antenna. This positional relationship of the card and phone antennas may tend to prevent the potential problem described above in the “Background” section of this disclosure.

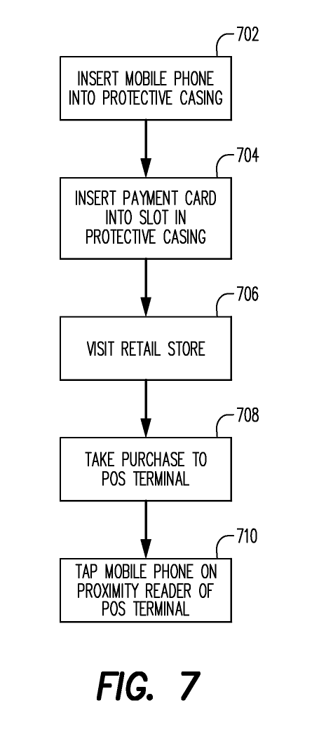

FIG. 7 is a flow chart that illustrates a process that may be performed according to aspects of the present invention.

At 702 in FIG. 7, the user inserts the mobile telephone 100 (FIG. 1) into the pouch 106 of the protective case 104. The protective case may be as described hereinabove in connection with FIG. 1.

At 704, the user inserts a contactless payment card, such as the contactless payment card 102 described above, into the slot 108 in the protective case that holds the mobile telephone 100. In this way the payment card is removably secured to the mobile telephone, bringing about the condition schematically illustrated in FIG. 1.

At 706, the user takes the mobile telephone, bearing the protective case and the contactless payment card, with him/her while he/she visits a retail store. At 708, the user makes a selection of merchandise at the store and presents the merchandise for purchase at a POS terminal in the store. After the sales clerk has entered the items to be purchased into the POS terminal (e.g., by scanning barcodes on the merchandise), the user effects payment for the transaction. This may be done when the user taps (step 710) the mobile telephone (e.g., with the payment card side down) on the proximity reader component of the POS terminal. With the payment card thus or otherwise brought into proximity with the reader, wireless communications are exchanged between the payment card and the reader. In this manner, the user's payment card account number is communicated from the contactless payment card to the POS terminal and used to authorize and settle the purchase transaction.

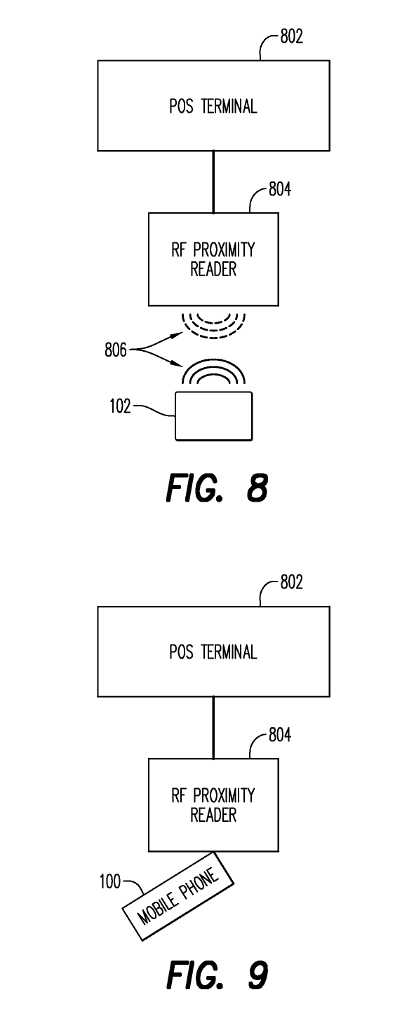

FIG. 8 schematically illustrates some communication aspects of the purchase transaction. The POS terminal is represented at block 802, and block 804 represents the proximity reader interfaced to or incorporated in the POS terminal 802. The contactless payment card is indicated at 102, and the wireless communication between the contactless payment card 102 and the proximity reader 804 is indicated at 806.

FIG. 9 schematically illustrates some physical aspects of the purchase transaction. As in FIG. 8, the POS terminal 802 and its associated proximity reader 804 are shown. The mobile phone 100 is also shown in proximity to the proximity reader 804. It is assumed that the mobile phone includes the arrangement of FIG. 1, whereby the protective case (not separately shown in FIG. 9) has been fitted onto the mobile phone and the contactless payment card (not separately shown in FIG. 9) is secured to the mobile phone by having been inserted into the slot (not shown) of the protective case.

The mobile telephone 100 contains a battery (not separately shown) or other components that may tend to short out the antenna of the contactless payment card 102 and thus may tend to interfere with the operation of the contactless payment card 102. To aid in addressing this issue, and as illustrated by item 112 in FIG. 1 of the above-referenced '367 patent application, the protective case 104 may include a layer of ferrite or other ferromagnetic material to shield the contactless payment card 102 (and particularly, the card antenna) from the interfering effects of components of the mobile telephone 100, thereby shielding communications to the contactless payment card 102 from interference from components of the mobile telephone 100. To simplify the drawings, the ferrite shield layer is not shown in the drawings of the present disclosure.

In the foregoing description, it was assumed that the magnetic stripe and the RFID chip both stored the same payment card account number, namely the PAN (primary account number) shown on the front surface of the contactless payment card 102. However, in some embodiments, whilst the magnetic stripe stores the PAN, the RFID chip may instead store a special or proxy payment card account number to be used only for contactless payment transactions (in accordance with teachings of U.S. published patent application no. 2008/0306850). It will be appreciated that the PAN stored in the magnetic stripe is used for transactions in which the magnetic stripe is “swiped” through a magnetic stripe reader component of a POS terminal; such transactions may be considered to be “swipe transactions”.

Up to this point, the invention has been discussed in terms of contactless payment cards. Alternatively, however, the principles of the invention may be applied to other types of contactless identification cards, such as those used to permit access to a transit system, or those used to identify participants in a customer loyalty system.

In some embodiments, the card antenna may also be configured to be distant from the left edge of the payment card by about one inch or more, to allow for the payment card to be inserted into the mobile phone case slot with its left edge leading rather than with its right edge leading.

The above descriptions and depictions of processes, including FIG. 7, should not be considered to mandate a fixed order for performing process steps. Rather the steps may be performed in any order that is practicable.

For purposes of the appended claims, one item is to be deemed “offset” from another item, if the two items do not overlap in space, or are spaced apart from each other.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A payment card comprising:
an ID-1-sized plastic body, having a left edge, a right edge, a top edge and a bottom edge;
an integrated circuit (IC) embedded in the plastic body and storing a payment card account number;
an antenna coupled to the IC for selectively transmitting the payment card account number from the payment card, the antenna embedded in or printed on the plastic body and configured such that no portion of the antenna is closer than about one inch from the right edge of the plastic body; and
a magnetic stripe formed on a rear surface of the plastic body and storing said payment card account number.

2. The payment card of claim 1, wherein the magnetic stripe is configured such that the magnetic stripe extends from the left edge of the plastic body toward the right edge of the plastic body and no portion of the magnetic stripe is closer than about one inch from the right edge of the plastic body.

3. The payment card of claim 1, wherein:
the payment card account number is embossed on the plastic body as 16 human-readable numerals, including a twelfth numeral and a thirteenth numeral; and
a course of the antenna passes between the twelfth and thirteenth numerals of the embossed payment card account number.

4. The payment card of claim 1, wherein the antenna is offset from the bottom edge of the plastic body.

5. The payment card of claim 1, wherein a left course of the antenna is adjacent the left edge of the plastic body and a top course of the antenna is adjacent the top edge of the plastic body.

6. A payment-enabled mobile-telephone assembly, comprising:
a mobile telephone comprising a touch screen and an operating system, the mobile telephone having a telephone antenna by which voice and data are transmitted to and from the mobile telephone;
a case installed on the mobile telephone; and
an IC (integrated circuit) payment card inserted in the case;
wherein the IC payment card comprises:
an ID-1-sized plastic body, having a left edge, a right edge, a top edge and a bottom edge;
an integrated circuit (IC) embedded in the plastic body and storing a payment card account number;
a card antenna coupled to the IC for selectively transmitting the payment card account number from the payment card, the card antenna embedded in or printed on the plastic body and configured such that no portion of the card antenna is closer than about one inch from the right edge of the plastic body; and
a magnetic stripe formed on a rear surface of the plastic body and storing said payment card account number;
wherein the card antenna is offset from the telephone antenna.

7. The payment-enabled mobile-telephone assembly of claim 6, wherein the magnetic stripe is configured such that the magnetic stripe extends from the left edge of the plastic body toward the right edge of the plastic body and no portion of the magnetic stripe is closer than about one inch from the right edge of the plastic body.

8. The payment-enabled mobile-telephone assembly of claim 6, wherein:
the payment card account number is embossed on the plastic body as 16 human-readable numerals, including a twelfth numeral and a thirteenth numeral; and
a course of the card antenna passes between the twelfth and thirteenth numerals of the embossed payment card account number.

9. The payment-enabled mobile-telephone assembly of claim 6, wherein the card antenna is offset from the bottom edge of the plastic body.

10. The payment-enabled mobile-telephone assembly of claim 6, wherein a left course of the card antenna is adjacent the left edge of the plastic body and a top course of the card antenna is adjacent the top edge of the plastic body.

11. The payment-enabled mobile-telephone assembly of claim 6, wherein the right edge of the plastic body overlies the telephone antenna.

12. A payment card comprising:
an ID-1-sized plastic body, having a left edge, a right edge, a top edge and a bottom edge;
an integrated circuit (IC) embedded in the plastic body and storing a contactless-transaction payment card account number;
an antenna coupled to the IC for selectively transmitting the contactless-transaction payment card account number from the payment card, the antenna embedded in or printed on the plastic body and configured such that no portion of the antenna is closer than about one inch from the right edge of the plastic body; and
a magnetic stripe formed on a rear surface of the plastic body and storing a swipe-transaction payment card account number, the swipe-transaction payment card account number different from the contactless-transaction payment card account number.

13. The payment card of claim 12, wherein the magnetic stripe is configured such that the magnetic stripe extends from the left edge of the plastic body toward the right edge of the plastic body and no portion of the magnetic stripe is closer than about one inch from the right edge of the plastic body.

14. The payment card of claim 12, wherein:
the swipe-transaction payment card account number is embossed on the plastic body as 16 human-readable numerals, including a twelfth numeral and a thirteenth numeral; and
a course of the antenna passes between the twelfth and thirteenth numerals of the embossed swipe-transaction payment card account number.

15. The payment card of claim 12, wherein the antenna is offset from the bottom edge of the plastic body.

16. The payment card of claim 12, wherein a left course of the antenna is adjacent the left edge of the plastic body and a top course of the antenna is adjacent the top edge of the plastic body.

17. A payment card comprising:
an ID-1-sized plastic body, having a left edge, a right edge, a top edge and a bottom edge;
an integrated circuit (IC) embedded in the plastic body and storing a payment card account number;
an antenna coupled to the IC for selectively transmitting the payment card account number from the payment card, the antenna embedded in or printed on the plastic body; and
a magnetic stripe formed on a rear surface of the plastic body and storing said payment card account number;
wherein the plastic body has a keep-out region formed along the right edge of the plastic body such that the antenna and the magnetic stripe are excluded from the keep-out region.

18. The payment card of claim 17, wherein:
the keep-out region extends substantially one inch from all of the right edge of the plastic body.

19. The payment card of claim 17, wherein the magnetic stripe extends substantially two-thirds of a width of the plastic body starting from the left edge of the plastic body toward the right edge of the plastic body.

20. The payment card of claim 17, wherein a length dimension of the magnetic stripe is parallel to the top and bottom edges of the plastic body.
